(19) United States
(12) Patent Application Publication
(10) Pub. No.: US 2026/0133360 A1
(43) Pub. Date: May 14, 2026

(54) ELECTRONIC DEVICE

(71) Applicant: InnoLux Corporation, Miao-Li County (TW)

(72) Inventors: Chi FANG, Miao-Li County (TW); Wei-Tsung HSU, Miao-Li County (TW)

(21) Appl. No.: 19/358,111

(22) Filed: Oct. 14, 2025

(30) Foreign Application Priority Data
Nov. 13, 2024 (CN) 202411615331.6

(51) Int. Cl. F21V 8/00

(52) U.S. Cl. CPC G02B 6/0053; G02B 6/0043; G02B 6/0056

(57) ABSTRACT

An electronic device includes: a backlight module including: a light guide plate; a plurality of light sources disposed adjacent to a light incident side of the light guide plate and arranged along a first direction; a first optical element disposed on the light guide plate and having a plurality of first prism structures, wherein at least one of the plurality of first prism structures extends along the first direction, and the plurality of the prism structures face the light guide plate.

### CROSS-REFERENCE TO RELATED APPLICATIONS

This application claims the benefits of the Chinese Patent Application Ser. No. 202411615331.6, filed on Nov. 13, 2024, the subject matter of which is incorporated herein by reference.

### BACKGROUND

### Field

The present disclosure relates to an electronic device. More specifically, the present disclosure relates to an electronic device with a backlight module.

### Description of Related Art

As consumers have higher quality requirements for electronic devices and hope for low cost, there is a need for high-quality and low-cost electronic device designs.

### SUMMARY

The present disclosure provides and electronic device, comprising: a backlight module, comprising: a light guide plate; a plurality of light sources disposed adjacent to a light incident side of the light guide plate and arranged along a first direction; a first optical element disposed on the light guide plate and having a plurality of first prism structures, wherein at least one of the plurality of first prism structures extends along the first direction, and the plurality of first prism structures face the light guide plate.

Other novel features of the disclosure will become more apparent from the following detailed description when taken in conjunction with the accompanying drawings.

### BRIEF DESCRIPTION OF DRAWINGS

FIG. 1A is a cross-sectional schematic view of a backlight module according to one embodiment of the present disclosure.

FIG. 1B is a three-dimensional schematic view of a backlight module according to one embodiment of the present disclosure.

FIG. 2A to FIG. 2C show optical analysis results of different aspects of backlight modules according to one embodiment of the present disclosure.

FIG. 3 is a cross-sectional schematic view of a backlight module according to one embodiment of the present disclosure.

FIG. 4A to FIG. 4C show optical analysis results of different aspects of backlight modules according to one embodiment of the present disclosure.

FIG. 5 is a cross-sectional schematic view of a backlight module according to one embodiment of the present disclosure.

FIG. 6A is a cross-sectional schematic view of a backlight module according to one embodiment of the present disclosure.

FIG. 6B and FIG. 6C are enlarged views of the third optical element of FIG. 6A.

FIG. 7 is a cross-sectional schematic view of a backlight module according to one embodiment of the present disclosure.

### DETAILED DESCRIPTION

The following is a detailed description of the electronic device according to the embodiment of the present disclosure. It should be understood that the following description provides many different embodiments for implementing different aspects of some embodiments of the present disclosure. Specific examples of each component and its configuration are described below to simplify the embodiments of the present disclosure. Of course, these are only examples and are not intended to limit the present disclosure. In addition, similar and/or corresponding reference numerals may be used to identify similar and/or corresponding elements in different embodiments to clearly describe the present disclosure. However, the use of these similar and/or corresponding reference numerals is only for the purpose of simply and clearly describing some embodiments of the present disclosure, and does not imply any correlation between the different embodiments and/or structures discussed.

The embodiments of the present disclosure may be understood in conjunction with the drawings, which are also considered part of the disclosure. It should be understood that the drawings of the present disclosure are not drawn to scale, and in fact, the size of the elements may be arbitrarily enlarged or reduced in order to clearly show the features of the present disclosure. In addition, the directional terms mentioned in the present disclosure, such as “up”, “down”, “front”, “back”, “left”, “right”, etc., are only referenced to the directions of the accompanying drawings. Therefore, the directional terms used are for illustration and are not intended to limit the present disclosure. In the accompanying drawings, each diagram depicts the general characteristics of the methods, structures and/or materials used in a particular embodiment. However, these diagrams should not be interpreted as defining or limiting the scope or nature covered by these embodiments. For example, for the sake of clarity, the relative size, thickness and position of each layer, region and/or structure may be reduced or enlarged.

One structure (or layer, component, or substrate) described in the present disclosure is located on/above another structure (or layer, component, or substrate). This may mean that the two structures are adjacent and directly connected, or the two structures are adjacent rather than directly connected. Indirect connection means that there is at least one intermediary structure (or intermediary layer, intermediary component, intermediary substrate, or intermediary spacer) between two structures. The lower surface of one structure is adjacent to or directly connected to the upper surface of the intermediary structure, and the upper surface of another structure is adjacent to or directly connected to the lower surface of the intermediary structure. The intermediary structure can be composed of a single-layer or multi-layer solid structure or a non-solid structure, and there is no limit. In the present disclosure, when a structure is disposed “on” another structure, it may mean that the structure is “directly” on the other structure, or that the structure is “indirectly” on the other structure, that is, at least one structure is also sandwiched between the structure and the other structure.

In addition, it should be understood that the ordinal numbers used in the description and the claims, such as “first”, “second”, etc., are intended only to describe the elements claimed and imply or represent neither that the (these) elements have any proceeding ordinals, nor that sequence between one claimed element and another claimed element or between steps of a manufacturing method. The use of these ordinals is merely to differentiate one claimed element having a certain designation from another claimed element having the same designation. The same words may not be used in the claim and the description. For example, the first element in the description may be the second element in the claim.

In some embodiments of the present disclosure, terms related to joining and connecting, such as “connection”, “interconnection”, etc., unless otherwise defined, may mean that two structures are in direct contact, or may also mean that two structures are not in direct contact where other structures are located between these two structures. The terms “joint” and “connection” can also include situations where both structures are movable, or where both structures are fixed. In addition, the terms “coupling” include any direct and indirect means of connection.

In the present specification, the terms, such as “about”, “substantially”, or “approximately”, are generally interpreted as within 10%, 5%, 3%, 2%, 1%, or 0.5% of a given value or range. Unless otherwise stated, when a value is “in a range from a first value to a second value” or “in a range between a first value and a second value”, the value can be the first value, the second value, or another value between the first value and the second value. In addition, any two values or directions used for comparison may have certain errors. If the first value is equal to the second value, it implies that there may be an error of about 10% between the first value and the second value. If the first direction is perpendicular to the second direction, the angle between the first direction and the second direction may be between 80° and 100°. If the first direction is parallel to the second direction, the angle between the first direction and the second direction may be between 0° and 10°. In the present disclosure, the term “the given range is from the first value to the second value” and “the given range falls within the range of the first value to the second value” mean that the given range includes the first value, the second value and another value between the first value and the second value.

Furthermore, according to some embodiments of the present disclosure, the thickness, the length, the width, or the distance and angle between elements may be measured by using an optical microscope (OM), scanning electron microscope (SEM), film thickness profiler (α-step), ellipsometer, or other suitable methods. More specifically, according to some embodiments, a scanning electron microscope can be used to obtain a cross-sectional image of the structure and measure the thickness, length, width of each element or the distance and angle between elements.

In the specification and the appended claims of the present disclosure, certain words are used to refer to specific elements. Those skilled in the art should understand that electronic device manufacturers may refer to the same components by different names. The present specification does not intend to distinguish between elements that have the same function but have different names. In the following description and claims, words such as “comprising”, “including”, “containing”, and “having” are open-ended words, so they should be interpreted as meaning “containing but not limited to . . . ”. Therefore, when the terms “comprising”, “including”, “containing” and/or “having” are used in the description of the present disclosure, they specify the existence of corresponding features, regions, steps, operations and/or components, but do not exclude the existence of one or more corresponding features, regions, steps, operations and/or components.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those known in the art, the background of the present disclosure or the context of the present specification, and should not be read by an ideal or over-formal way. The present disclosure may be understood by referring to the following detailed description taken in conjunction with the accompanying drawings. It should be noted that in order to make it easier for readers to understand and for the sake of simplicity, the various figures in the present disclosure only depict a portion of the electronic device. The specific elements in the drawings are not drawn in accordance with the actual scale. In addition, the number and size of each element in the figure are for illustration only and are not intended to limit the scope of the present disclosure.

The electronic device of the present disclosure may include electronic components, and the electronic components can include passive components, active components or a combination thereof, such as capacitors, resistors, inductors, varactor diodes, variable capacitors, filters, diodes, transistors, sensors, microelectromechanical system components (MEMS), liquid crystal chips, etc., but the present disclosure is not limited thereto. The diode may include light emitting diode or non-light emitting diode. The diode includes a P-N junction diode, a PIN diode or a constant current diode. The light emitting diode may include, for example, an organic light emitting diode (OLED), a mini LED, a micro LED, a quantum dot LED, fluorescence, phosphors, other suitable material or a combination thereof, but the present disclosure is not limited thereto. The sensor may include, for example, a capacitive sensor, an optical sensor, an electromagnetic sensor, a fingerprint sensor (FPS), a touch sensor, an antenna or a pen sensor, but the present disclosure is not limited thereto. The following will be a display device as an electronic device to illustrate the present disclosure, but the present disclosure is not limited thereto.

The electronic device may include an imaging device, a laminating device, a display device, a backlight device, an antenna device, a tiled device, a touch electronic device (a touch display), a curved electronic device (a curved display) or a non-rectangular electronic device (a free shape display), but the present disclosure is not limited thereto. The electronic device may include, for example, liquid crystals, light emitting diodes, fluorescence, phosphors, other suitable display media, or a combination thereof, but the present disclosure is not limited thereto. The display device may be a non-self-luminous display device or a self-luminous display device. The antenna device may be a liquid crystal antenna device or a non-liquid crystal antenna device. The sensing device may be a sensing device that can sense capacitance, light, heat energy or ultrasonic waves. But, the present disclosure is not limited thereto. The tiled device may be, for example, a tiled display device or a tiled antenna device, but is not limited thereto. It should be noted that the electronic device may be any combination of the above, but is not limited thereto. The electronic device may be a bendable or flexible electronic device. It should be noted that the electronic device may be any combination of the above, but not limited to this. In addition, the shape of the electronic device may be rectangular, circular, polygonal, or having a shape with curved edges or other suitable shapes. The electronic device may have peripheral systems such as drive systems, control systems, light source systems, shelf systems, etc. to support the display device, the antenna device or the tiled device.

It should be noted that the following embodiments may be implemented by replacing, reorganizing, or mixing features of several different embodiments without departing from the spirit of the present disclosure to implement other embodiments. The features of the various embodiments may be mixed and matched as desired as long as they do not violate the spirit of the invention or conflict with each other. It should be noted that the technical solutions provided in the following different embodiments can be replaced, combined or mixed with each other to form another embodiment without violating the spirit of the present disclosure.

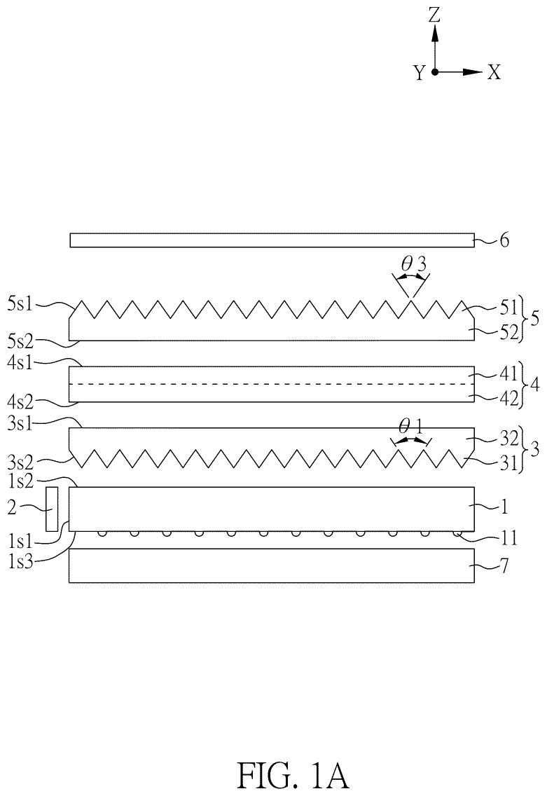

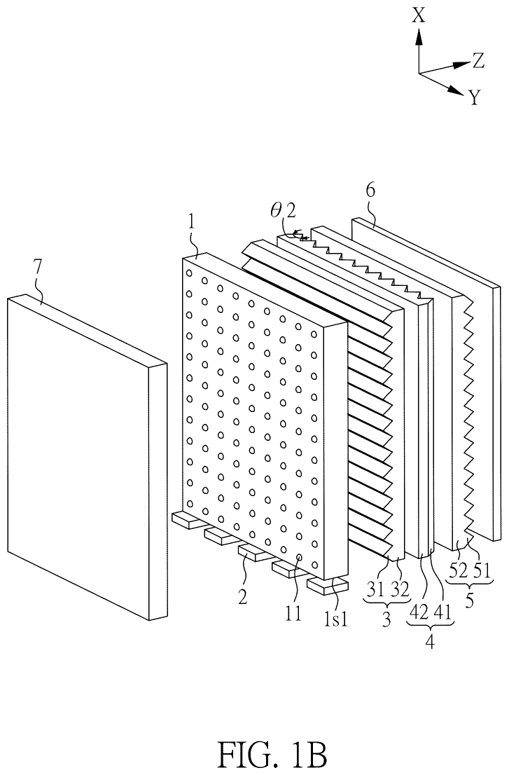

FIG. 1A is a cross-sectional schematic view of a backlight module according to one embodiment of the present disclosure. FIG. 1B is a three-dimensional schematic view of a backlight module according to one embodiment of the present disclosure.

In one embodiment of the present disclosure, the electronic device may comprise a backlight module. As shown in FIG. 1A and FIG. 1B, the backlight module may comprise: a light guide plate 1; a plurality of light sources 2 disposed adjacent to a light incident side 1s1 of the light guide plate 1 and extending along a first direction Y; a first optical element 3 disposed on the light guide plate 1 and having a plurality of first prism structures 31; wherein at least one of the first prism structures 31 extend along the first direction Y, and the first prism structures 31 face the light guide plate 1. More specifically, the first optical element 3 comprises a first upper surface 3s1 and a first lower surface 3s2 opposite to the first upper surface 3s1, wherein the first upper surface 3s1 is farther from the light guide plate 1 than the first lower surface 3s2, and the first lower surface 3s2 has a plurality of first prism structures 31. The first prism structures 31 may extend along the first direction Y, and the first prism structures 31 may have strip shapes and be arranged along a second direction X, in which the first direction Y may be substantially perpendicular to the second direction X. The “first prism structures facing the light guide plate” refers to, for example, the first prism structures 31 are closer to the light guide plate 1 than the first upper surface 3s1, or the first upper surfaces 3s1 are farther from the light guide plate 1 than the first prism structure 31.

In one embodiment of the present disclosure, as shown in FIG. 1A and FIG. 1B, the backlight module may further comprise a second optical element 4 disposed on the first optical element 3 and having a plurality of second prism structures 41, wherein at least one of the second prism structures 41 extends along the second direction X, and the second prism structures 41 are away from the light guide plate 1. More specifically, the second optical element 4 comprises a second upper surface 4s1 and a second lower surface 4s2 opposite to the second upper surface 4s1, wherein the second upper surface 4s1 is farther from the light guide plate 1 than the second lower surface 4s2, and the second upper surface 4s1 has a plurality of second prism structures 41. The second prism structures 41 may extend along the second direction X, and the second prism structures 41 may have strip shapes and arranged along the first direction Y. The “second prism structures away from the light guide plate” refers to, for example, the second prism structure 41 is farther from the light guide plate 1 than the second lower surface 4s2, or the second lower surface 4s2 is closer to the light guide plate 1 than the second prism structure 41.

In one embodiment of the present disclosure, as shown in FIG. 1A and FIG. 1B, the backlight module may further comprise a third optical element 5 disposed on the second optical element 4 and having a plurality of third prism structures 51, wherein at least one of the third prism structures 51 extends along the first direction Y, and the third prism structure 51 is away from the light guide plate 1. More specifically, the third optical element 51 comprises a third upper surface 5s1 and a third lower surface 5s2 opposite to the third upper surface 5s1, wherein the third upper surface 5s1 is farther from the light guide plate 1 than the third lower surface 5s2, and the third upper surface 5s1 has a plurality of third prism structures 51. The third prism structures 51 may extend along the first direction Y, and the plurality of third prism structures 51 may have strip shapes and be arranged along the second direction X. The “third prism structures away from the light guide plate” refers to, for example, the third prism structure 51 is farther from the light guide plate 1 than the third lower surface 5s2, or the third lower surface 5s2 is closer to the light guide plate 1 than the third prism structure 51.

In one embodiment of the present disclosure, as shown in FIG. 1A and FIG. 1B, the light guide plate 1 has an upper surface 1s2, a lower surface 1s3 and a light incident side 1s1, wherein the light incident side 1s1 respectively connects to the upper surface 1s2 and the lower surface 1s3 and adjacent to the light source 2, the upper surface 1s2 is opposite to the lower surface 1s3, and the lower surface 1s3 is farther from the first optical element 3 than the upper surface 1s2. In one embodiment of the present disclosure, the light guide plate 1 may have a plurality of dot structures 11 disposed on the lower surface 1s3 of the light guide plate 1, wherein the dot structures 11 may be used to improve the light guide efficiency of the light guide plate 1. In the present disclosure, the material of the light guide plate 1 may comprise glass, polycarbonate (PC), polymethylmethacrylate (PMMA), polyethylene terephthalate (PET), suitable high light transmittance material or a combination thereof, but the present disclosure is not limited thereto. In the present disclosure, the light source 2 may comprise a light emitting diode, which may comprise, for example, an organic light emitting diode (OLED), a mini LED, a micro LED, a quantum dot LED (which may comprise QLED or QDLED), fluorescence, phosphors, other suitable material or a combination thereof, but the present disclosure is not limited thereto.

In one embodiment of the present disclosure, as shown in FIG. 1A and FIG. 1B, the first optical element 3 comprises a base 32, and the first prism structure 31 is disposed on the base 32; the second optical element 4 comprises a base 42, and the second prism structure 41 is disposed on the base 42; and the third optical element 5 comprises a base 52, and the third prism structure 51 is disposed on the base 52. In the present disclosure, the materials of the base 32, the base 42, the base 52, the first prism structure 31, the second prism structure 41 and/or the third prism structure 51 may respectively comprise polycarbonate (PC), polyimide (PI), polyethylene terephthalate (PET), polyether polyol (POP), polymethylmethacrylate (PMMA), cycloolefin polymer (COP), rubber, glass, other suitable material or a combination thereof, but the present disclosure is not limited thereto. The materials of the first prism structures 31 and the base 32 may be the same or different. The materials of the second prism structures 41 and the base 42 may be the same or different. The materials of the third prism structures 51 and the base 52 may be the same or different. In one embodiment of the present disclosure, the materials of the first prism structure 31, the second prism structure 41 and the third prism structure 51 may respectively comprise photo-curing adhesive, thermal-curing adhesive, photo-thermal-curing adhesive, moisture-curing adhesive, other suitable materials or a combination thereof, but the present disclosure is not limited thereto. In one embodiment of the present disclosure, the materials of the first prism structures 31, the second prism structures 41 and the third prism structures 51 may respectively comprise optical clear adhesive (OCA), optical clear resin (OCR), acrylic resin, other suitable materials or a combination thereof, but the present disclosure is not limited thereto.

In one embodiment of the present disclosure, the refractive index n1 of the first optical element 3 (for example, the first prism structures 31), the refractive index n2 of the second optical element 4 (for example, the second prism structures 41) and the refractive index n3 of the third optical element 5 (for example, the third prism structures 51) may be the same or different, and may respectively range from 1.45 to 1.75 (that is, 1.45≤n1≤1.75; 1.45≤n2≤1.75; 1.45≤n3≤1.75), for example, may respectively range from 1.5 to 1.7 (that is, 1.5≤n1≤1.7; 1.5≤n2≤1.7; 1.5≤n3≤1.7), for example, may respectively range from 1.6 to 1.7 (that is, 1.6≤n1≤1.7; 1.6≤n2≤1.7; 1.6≤n3≤1.7), but the present disclosure is not limited thereto. The above refractive index n1, refractive index n2 and refractive index n3 are refractive indexes relative to visible light. In the present disclosure, the refractive index of one element refers to the refractive index relative to visible light.

In one embodiment of the present disclosure, the refractive index n1 of the first optical element 3 (for example, the first prism structures 31) and the refractive index n3 of the third optical element 5 (for example, the third prism structures 51) may respectively less than 1.62 (that is, n1<1.62; n3<1.62), for example, the refractive index n1 of the first optical element 3 (for example, the first prism structures 31) and the refractive index n3 of the third optical element 5 (for example, the third prism structures 51) may respectively range from 1.45 to 1.61 (that is, 1.45≤n1≤1.61; 1.45≤n3≤1.61) or from 1.5 to 1.55 (that is, 1.5≤n1≤1.55; 1.5≤n3≤1.55), but the present disclosure is not limited thereto. In one embodiment of the present disclosure, the refractive index n2 of the second optical element 4 (for example, the second prism structures 41) may be greater than or equal to 1.62 (that is, 1.62≤n2), for example, may range from 1.62 to 1.7 (that is, 1.62≤n2≤1.7), from 1.62 to 1.68 (that is, 1.62≤n2≤1.68) or from 1.62 to 1.65 (that is, 1.62≤n2≤1.65). When the refractive index n1 of the first optical element 3 (for example, the first prism structures 31), the refractive index n2 of the second optical element 4 (for example, the second prism structures 41) and the refractive index n3 of the third optical element 5 (for example, the third prism structures 51) meet the above design, the light emitting efficiency of the backlight module can be improved. In the present disclosure, the “refractive index of an optical element” refers to, for example, the refractive index of the prism structure of the optical element. For example, the refractive index n1 of the first optical element 3 may be the refractive index of the first prism structures 31, the refractive index n2 of the second optical element 4 may be the refractive index of the second prism structures 41, and the refractive index n3 of the third optical element 5 may be the refractive index of the third prism structures 51.

In one embodiment of the present disclosure, the first prism structures 31 may have a first vertex angle θ1, the second prism structures 41 may have a second vertex angle θ2, and the third prism structures 51 may have a third vertex angle θ3. In the present disclosure, the first vertex angle θ1, the second vertex angle θ2 and the third vertex angle θ3 may be the same or different, and may respectively range from 80° to 100° (that is, 80°≤θ1≤100°; 80°≤θ2≤100°; 80°≤θ3≤100°), for example, may respectively range from 85° to 95° (that is, 85°≤θ1≤95°; 85°≤θ2≤95°; 85°≤θ3≤95°), but the present disclosure is not limited thereto. In one embodiment of the present disclosure, the first vertex angle θ1, the second vertex angle θ2 and the third vertex angle θ3 may respectively be 90°. When the first vertex angle θ1, the second vertex angle θ2 and the third vertex angle θ3 meet the aforesaid range, the (production) cost of the first prism structures 31, the second prism structures 41 and the third prism structures 51 can be reduced.

In one embodiment of the present disclosure, as shown in FIG. 1A and FIG. 1B, the backlight module may selectively comprise a functional layer 6 disposed on the third optical element 5, the functional layer 6 may comprise a diffuser, an advanced polarization conversion film (APCF), a dual brightness enhancement film (DBEF) or a combination thereof, but the present disclosure is not limited thereto. The functional layer 6 may be used to improve the light emitting efficiency of the backlight module and/or improving the display quality.

In one embodiment of the present disclosure, as shown in FIG. 1A and FIG. 1B, the backlight module further comprise a reflective element 7 disposed under the light guide plate 1 and be used to reflect the light emitted from the lower surface 1s3 of the light guide plate 1, so that the light travels toward the upper surface 1s2 of the light guide plate 1 to improve the utilization rate of the light. In the present disclosure, the material of the reflective element 7 is not particularly limited, and may comprise, for example, a metal, white ink, other reflective materials or a combination thereof. The metal may comprise gold, silver, copper, aluminum or a combination thereof, but the present disclosure is not limited thereto. The white ink may comprise white polyimide, resin or a combination thereof, but the present disclosure is not limited thereto. In addition, the reflective element 7 may comprise single or multi-layer reflective film.

In the present disclosure, even not shown in the figure, the backlight module may selectively further comprise a support frame, a circuit board, other suitable elements or a combination thereof, which are not described again here. In the present disclosure, even not shown in the figure, the electronic device further comprise a display panel disposed on the backlight module, and the display panel may comprise upper and lower substrates, a display medium, a sealant, an alignment film, a polarizer, a light shielding layer, a color filter layer and/or a driving element, and other suitable elements or a combination thereof, but the present disclosure is not limited thereto.

In the present disclosure, by designing the arrangement of the first optical element 3, the second optical element 4 and/or the third optical element 5, for example, designing the first prism structures 31, the second prism structures 41 and the third prism structures 51 respectively extending along the first direction Y or the second direction X, or designing the relationship between the first prism structures 31, the second prism structures 41 and the third prism structures 51 respectively facing or away from the light guide plate 1, the light emitted from the backlight module can focus toward the positive viewing angle, thereby improving the light emitting efficiency of the backlight module.

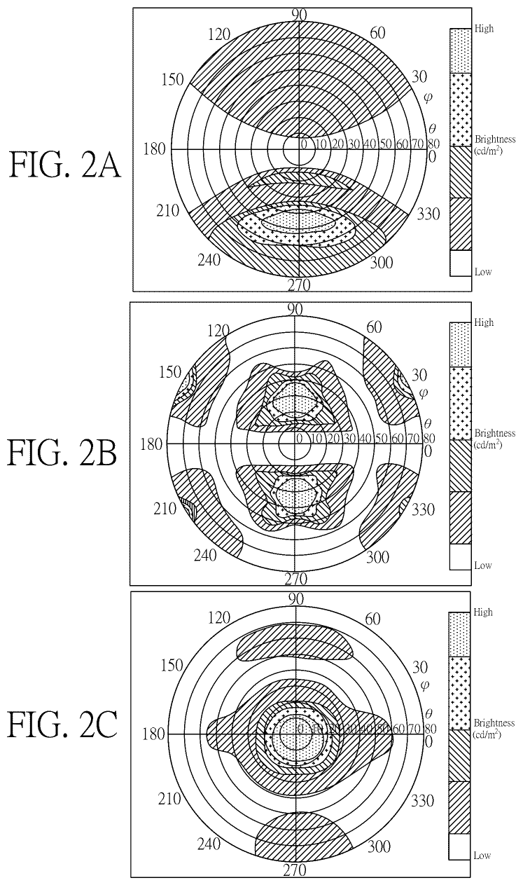

FIG. 2A to FIG. 2C show optical analysis results of different aspects of backlight modules according to one embodiment of the present disclosure.

FIG. 2A to FIG. 2C respectively show optical analysis results of backlight modules with different optical films, wherein the used optical films may be the light guide plate 1, the first optical element 3, the second optical element 4, the third optical element 5 and the functional layer 6 (for example, a diffuser) as shown in FIG. 1A and FIG. 1B, which are not described again here. These optical analysis results can be obtained by measuring or analyzing by, for example, using a spectral integrated imaging visual angle meter, a conoscope or other suitable instruments to obtain the results, but the present disclosure is not limited thereto.

The optical analysis results of FIG. 2A to FIG. 2C may comprise the azimuth angle φ (the azimuth angle ranging from 0° to 360° as shown in the figure) and the tilt angle θ (the tilt angle ranging from 0° to 80° as shown in the figure). The tilt angle θ may be, for example, the angle with the normal direction Z of the light guide plate 1 (as shown in FIG. 1A), and the tilt angle θ of 0° may represent the vertical direction of the upper surface 1s2 of the light guide plate 1. The azimuth angle φ may be, for example, the angle parallel to the upper surface 1s2 of the light guide plate 1, and the position of the azimuth angle φ of 270° may substantially correspond to the position of the light incident side 1s1 of the light guide plate 1. In addition, the color scales on the right side of FIG. 2A to FIG. 2C represent different ranges of brightness per unit area (cd/m²), and the brightness increases gradually from bottom to top. This range of brightness per unit area (cd/m²) is only for illustrating the results of one embodiment, but the present disclosure is not limited thereto, and the brightness per unit area may vary depending on other factors.

In one embodiment of the present disclosure, when the backlight module comprises the light guide plate 1 and the first optical element 3, the obtained optical analysis result may be as shown in FIG. 2A. When light passes through the light guide plate 1 and the first optical element 3, the light may be approximately dispersed into two parts (such as the upper part and the lower part in FIG. 2A) by the first optical element 3. The light in the upper part can be located in the azimuth angle φ in the range about 30 degrees to about 150 degrees, and the tilt angle θ is mainly concentrated in the range of about 10 degrees to about 80 degrees. The light in the lower part can be located in the azimuth angle φ in the range about 210 degrees to about 330 degrees, and the tilt angle θ is mainly concentrated in the range of about 10 degrees to about 80 degrees. However, the present disclosure is not limited thereto.

In the case that the second optical element 4, the third optical element 5 and the functional layer 6 (for example, the diffuser) are sequentially disposed on the light guide plate 1 and the first optical element 3 of the backlight module, the obtained optical analysis results may be as shown in FIG. 2B and FIG. 2C. More specifically, as shown in FIG. 2B, when light passes through the light guide plate 1, the first optical element 3 and the second optical element 4, the splitting of the two parts (the upper part and the lower part) of FIG. 2A may be changed, for example, toward the positive viewing angle (that is, the closer the tilt angle θ is to 0 degrees). For example, the two parts shown in FIG. 2A may approximately correspond to a position where the tilt angle θ is approximately 10 degrees to 80 degrees, while the positions of the two parts shown in FIG. 2B are changed to a position where the tilt angle θ is approximately 10 degrees to 60 degrees, but the present disclosure is not limited thereto. In other words, after the light passes through the second optical element 4, the two parts of the light will be concentrated toward the positive viewing angle. In addition, as shown in FIG. 2C, when light passes through the light guide plate 1, the first optical element 3, the second optical element 4, the third optical element 5 and the functional layer 6 (for example, the diffuser), the two parts of the split light, for example, can be concentrated together, so that the light is concentrated at the positive viewing angle position of the electronic device. In the present disclosure, the backlight module can be designed with the relative relationship of the light guide plate 1, the first optical element 3, the second optical element 4 and the third optical element 5, so that the electronic device has the characteristic of focusing light toward the positive viewing angle, thereby improving the brightness of the positive viewing angle and achieving the effects of reducing energy consumption or improving contrast.

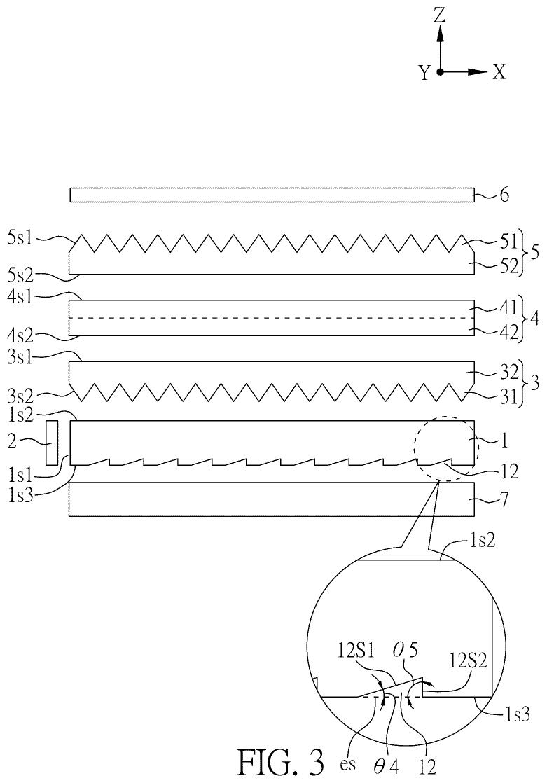

FIG. 3 is a cross-sectional schematic view of a backlight module according to one embodiment of the present disclosure. The backlight module of FIG. 3 is similar to that of FIG. 1A and FIG. 1B, except for the following differences.

In one embodiment of the present disclosure, as shown in FIG. 3, the lower surface 1s3 of the light guide plate 1 may have a plurality of concave microstructures 12, which may be used to improve the light guide efficiency of the light guide plate 1. In the present disclosure, in a cross-sectional view, the shapes of the concave microstructures 12 may be, for example, triangle, wherein the concave microstructure comprises a first side surface 12S1 and a second side surface 12S2, an angle between the first side surface 12S1 and the extension surface es of the lower surface 1s3 of the light guide plate 1 may be a first angle θ4, and an angle between the second side surface 12S2 and the extension surface es of the lower surface 1s3 of the light guide plate 1 may be a second angle θ5. In one embodiment of the present disclosure, the first angle θ4 may be different from the second angle θ5, but the present disclosure is not limited thereto.

In the present disclosure, other elements of the backlight module may be as those of FIG. 1A and FIG. 1B, which are not described again here.

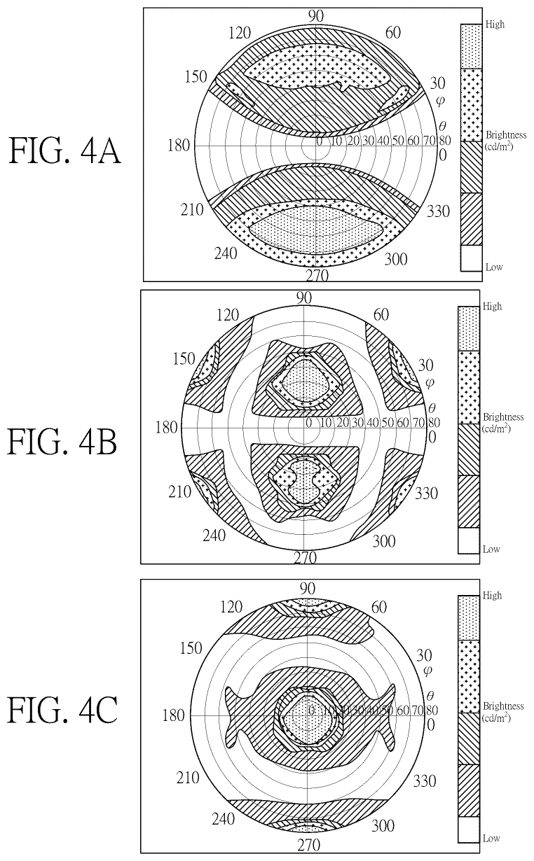

FIG. 4A to FIG. 4C show optical analysis results of different aspects of backlight modules according to one embodiment of the present disclosure. The analysis method of FIG. 4A to FIG. 4C is similar to that of FIG. 2A to FIG. 2C, except that the used backlight modules are different.

FIG. 4A to FIG. 4C respectively show optical analysis results of backlight modules with different optical films, wherein the used optical films may be the light guide plate 1, the first optical element 3, the second optical element 4, the third optical element 5 and the functional layer 6 (for example, the diffuser) as shown in FIG. 3, which are not described again here.

In one embodiment of the present disclosure, when the backlight module comprises the light guide plate 1 and the first optical element 3, the obtained optical analysis result may be as shown in FIG. 4A. When light passes through the light guide plate 1 and the first optical element 3, the light may be approximately dispersed into two parts (such as the upper part and the lower part in FIG. 4A) by the first optical element 3. The light in the upper part can be located in the azimuth angle φ in the range about 30 degrees to about 150 degrees, and the tilt angle θ is mainly concentrated in the range of about 10 degrees to about 80 degrees. The light in the lower part can be located in the azimuth angle φ in the range about 210 degrees to about 330 degrees, and the tilt angle θ is mainly concentrated in the range of about 10 degrees to about 80 degrees. However, the present disclosure is not limited thereto.

In the case that the second optical element 4, the third optical element 5 and the functional layer 6 (for example, the diffuser) are sequentially disposed on the light guide plate 1 and the first optical element 3 of the backlight module, the obtained optical analysis results may be as shown in FIG. 4B and FIG. 4C. More specifically, as shown in FIG. 4B, when light passes through the light guide plate 1, the first optical element 3 and the second optical element 4, the splitting of the two parts (the upper part and the lower part) of FIG. 4A may be changed, for example, toward the positive viewing angle (that is, the closer the tilt angle θ is to 0 degrees). For example, the two parts shown in FIG. 4A may approximately correspond to a position where the tilt angle θ is approximately 10 degrees to 80 degrees, while the positions of the two parts shown in FIG. 4B are changed to a position where the tilt angle θ is approximately 10 degrees to 60 degrees, but the present disclosure is not limited thereto. In other words, after the light passes through the second optical element 4, the two parts of the light will be concentrated toward the positive viewing angle. In addition, as shown in FIG. 4C, when light passes through the light guide plate 1, the first optical element 3, the second optical element 4, the third optical element 5 and the functional layer 6 (for example, the diffuser), the two parts of the split light, for example, can be concentrated together, so that the light is concentrated at the positive viewing angle position of the electronic device. In the present disclosure, the backlight module can be designed with the relative relationship of the light guide plate 1, the first optical element 3, the second optical element 4 and the third optical element 5, so that the electronic device has the characteristic of focusing light toward the positive viewing angle, thereby improving the brightness of the positive viewing angle and achieving the effects of reducing energy consumption or improving contrast.

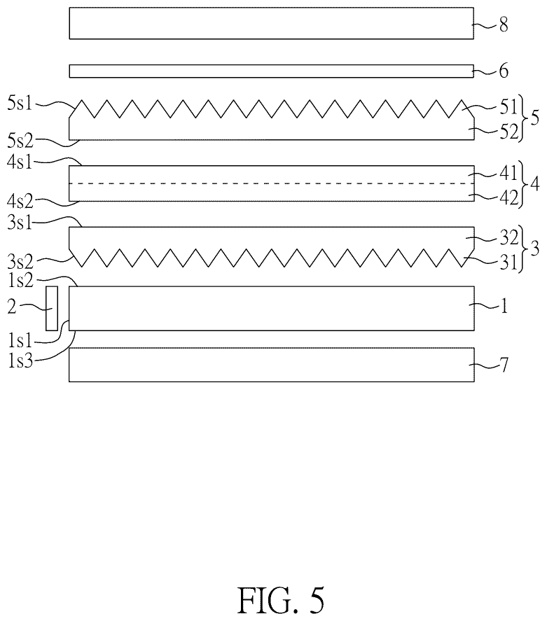

FIG. 5 is a cross-sectional schematic view of a backlight module according to one embodiment of the present disclosure. The backlight module of FIG. 5 is similar to those of FIG. 1A and FIG. 3, except for the following differences.

In one embodiment of the present disclosure, as shown in FIG. 5, the backlight module may selectively comprise another functional layer 8 disposed on the third optical element 5, and the functional layer 8 may comprise an advanced polarization conversion film (APCF), a dual brightness enhancement film (DBEF) or a combination thereof, but the present disclosure is not limited thereto. The functional layer 8 may be used to improve the light emitting efficiency of the backlight module and/or improving the display quality, thereby achieving the effect of saving costs and/or improving display quality.

In one embodiment of the present disclosure, when the backlight module comprises the functional layer 6 and the functional layer 8 at the same time, the functional layer 6 may be disposed between the functional layer 8 and the third optical element 5, and the functional layer 6 may be different from the functional layer 8. In one embodiment, the functional layer 6 may be a diffuser, and the functional layer 8 may be an advanced polarization conversion film (APCF), but the present disclosure is not limited thereto. In another embodiment, the functional layer 6 may be a dual brightness enhancement film (DBEF), and the functional layer 8 may be an advanced polarization conversion film (APCF), but the present disclosure is not limited thereto.

In the present disclosure, even not shown in the figure, the lower surface 1s3 of the light guide plate 1 shown in FIG. 5 may be disposed with a plurality of dot structures 11 shown in FIG. 1A; or the lower surface 1s3 of the light guide plate 1 shown in FIG. 5 may have a plurality of concave microstructures 12 shown in FIG. 3, but the present disclosure is not limited thereto. In addition, other elements of the backlight module may be as described above and are not described again here.

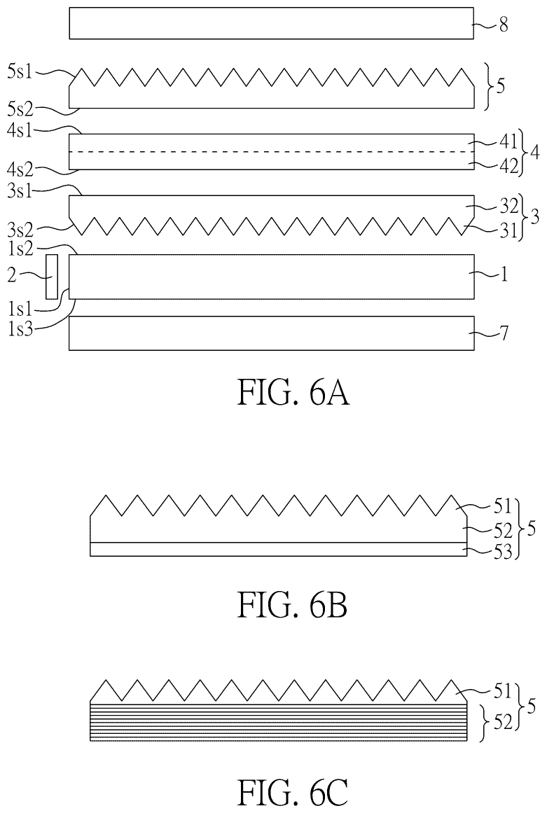

FIG. 6A is a cross-sectional schematic view of a backlight module according to one embodiment of the present disclosure. FIG. 6B and FIG. 6C are enlarged views of the third optical element of FIG. 6A. The backlight module of FIG. 6A is similar to that of FIG. 5, except for the following differences.

In one embodiment of the present disclosure, as shown in FIG. 6A and FIG. 6B, the third optical element 5 comprises a base 52, and the third prism structures 51 are disposed on the base 52, wherein a surface of the base 52 away from the third prism structures 51 has a haze greater than or equal to 15% and less than or equal to 45%. The materials of the third prism structures 51 and the base 52 may be the same or different. The third lower surface 5s2 of the third optical element 5 may have a structure 53 with haze. The structure 53 with haze can be obtained by texturing, sandblasting or other suitable processes on the base 52, but the present disclosure is not limited thereto. In one embodiment of the present disclosure, the structure 53 with haze may be obtained by hard coating the base 52 and/or applying diffusion particles to the material of the base 52, but the present disclosure is not limited thereto. Thus, the backlight module can maintain good optical quality or improve light emitting efficiency without setting up the functional layer 6 (as shown in FIG. 5), thereby achieving the effect of cost saving.

In one embodiment of the present disclosure, as shown in FIG. 6A and FIG. 6C, the third optical element 5 comprises a base 52 having a multilayer structure, and the third prism structures 51 are disposed on the multilayer structure. More specifically, the multilayer structure may be composed of N layers of non-single refractive index films (N is a positive integer greater than 2). For example, the multilayer structure may comprise a plurality of high refractive index films and a plurality of low refractive index films, wherein the high refractive index films and the low refractive index films are alternately disposed, and the third prism structures 51 may be disposed on the multilayer structure. By the design of the multilayer structure, the base 52 of the third optical element 5 may be used to reflect the polarized light provided by the light source 2, thereby increasing the light emitting amount of the backlight module. Thus, the backlight module may maintain or improve the light emitting efficiency without setting the functional layer 6 (as shown in FIG. 5), thereby achieving the effect of cost saving.

In the present disclosure, even not shown in the figure, the lower surface 1s3 of the light guide plate 1 shown in FIG. 6A may be disposed with the plurality of dot structures 11 shown in FIG. 1A; or the lower surface 1s3 of the light guide plate 1 shown in FIG. 6A may have a plurality of concave microstructures 12 shown in FIG. 3, but the present disclosure is not limited thereto. In addition, other elements of the backlight module may be as described above, and are not described again here.

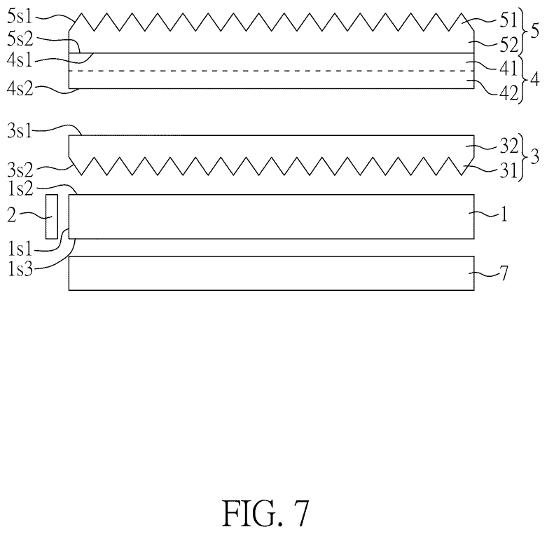

FIG. 7 is a cross-sectional schematic view of a backlight module according to one embodiment of the present disclosure. The backlight module shown in FIG. 7 is similar to those shown in FIG. 1A and FIG. 3, except for the following differences.

In one embodiment of the present disclosure, as shown in FIG. 7, the second optical element 4 and the third optical element 5 of the backlight module may be integrated into one body to form an optical film assembly. For example, the backlight module may further comprise an adhesive layer (not shown in the figure) disposed between the second optical element 4 and the third optical element 5, and the second optical element 4 and the third optical element 5 may be adhered to each other through the adhesive layer, but the present disclosure is not limited thereto. By integrating the second optical element 4 and the third optical element 5, relative positional deviation between the components during assembly can be reduced or the assembly process can be reduced. In the present disclosure, the material of the adhesive layer may comprise photo-curing adhesive, thermal-curing adhesive, photo-thermal-curing adhesive, moisture-curing adhesive, adhesive tape, other suitable materials, or a combination thereof, but the present disclosure is not limited thereto. In one embodiment, the adhesive layer may comprise polyvinyl butyral (PVB), ethylene vinyl acetate (EVA), thermoplastic polyurethane (TPU), optical clear adhesive (OCA), optical clear resin (OCR), other suitable material or a combination thereof, but the present disclosure is not limited thereto.

In the present disclosure, even not shown in the figure, the lower surface 1s3 of the light guide plate 1 shown in FIG. 7 may be disposed with a plurality of dot structures 11 shown in FIG. 1A; or the lower surface 1s3 of the light guide plate 1 shown in FIG. 7 may have a plurality of concave microstructures 12 shown in FIG. 3, but the present disclosure is not limited thereto. In addition, other elements of the backlight module may be referred to those described above and are not described again here.

### Light Emitting Efficiency of the Backlight Module

The first optical element 3 in the backlight module shown in FIG. 3 is replaced by a diffuser as a comparative example, and the light emitting efficiency of the backlight module of the comparative example is set to 100% to study the light emitting efficiency of the backlight module, wherein the functional layer 6 in the backlight module is a diffuser.

According to the combination of different optical films shown in Table 1 below, the light emitting efficiency of the backlight module of each embodiment is measured. Herein, “O” means the backlight module contains this component, and “X” means the backlight module does not contain this component. Another functional layer 8 is an advanced polarization conversion film (APCF) as an example. It should be noted that the combination of optical films in the following embodiments is used as an example to study the light emitting efficiency of the backlight module, and does not limit the backlight module disclosed in the present disclosure to be designed only in the following manner.

TABLE 1

| | First | Second | Third | | | Light |
|---|---|---|---|---|---|---|
| | optical | optical | optical | Functional | Functional | emitting |
| | element | element | element | layer 6 | layer 8 | efficiency |
| Comparative | Diffuser | ◯ | ◯ | ◯^{d} | X | 100% |
| example | | | | | | |
| Embodiment 1 | ◯ | ◯ | ◯ | ◯^{d} | X | 104% |
| Embodiment 2 | ◯ | ◯^{a} | ◯ | ◯^{d} | X | 112% |
| Embodiment 3 | ◯ | ◯^{a} | ◯^{b} | X | X | 114% |
| Embodiment 4 | ◯ | ◯ | ◯ | ◯^{e} | X | 140% |
| Embodiment 5 | ◯ | ◯ | ◯ | ◯^{d} | ◯ | 140% |
| Embodiment 6 | ◯ | ◯^{a} | ◯ | ◯^{e} | X | 145% |
| Embodiment 7 | ◯ | ◯ | ◯^{b} | X | ◯ | 145% |
| Embodiment 8 | ◯ | ◯^{a} | ◯ | ◯^{d} | ◯ | 150% |
| Embodiment 9 | ◯ | ◯ | ◯^{c} | X | X | 150% |
| Embodiment 10 | ◯ | ◯^{a} | ◯^{b} | X | ◯ | 155% |
| Embodiment 11 | ◯ | ◯^{a} | ◯^{c} | X | X | 163% |

◯: The refractive index of the first optical element 3 (for example, the first prism structures 31) ranges from 1.53 to 1.55; the refractive index of the second optical element 4 (for example, the second prism structures 41) ranges from 1.53 to 1.55; or the refractive index of the third optical element 5 (for example, the third prism structures 51) ranges from 1.53 to 1.55.
◯^{a}The refractive index of the second optical element 4 ranges from 1.62 to 1.65.
◯^{b}The third optical element 5 has the structure shown in FIG. 6B.
◯^{c}The third optical element 5 has the structure shown in FIG. 6C.
◯^{d}The functional layer 6 is a diffuser.
◯^{e}The functional layer 6 is a dual brightness enhancement film (DBEF).

From the above experimental results, it can be found that the backlight module disclosed herein can increase the light emitting efficiency by about 4% to 63% compared to the comparative example. In addition, by observing Embodiments 1-2, Embodiments 4 and 6, Embodiments 5 and 8, Embodiments 7 and 10, and Embodiments 9 and 11, it can be found that in the backlight modules with the same structures, increasing the refractive index of the second optical element 4 can improve the light emitting efficiency of the backlight module. In addition, the present disclosure also found that when the light guide plate 1 in the backlight module is replaced with the structure shown in FIG. 1A (i.e., the lower surface 1s3 of the light guide plate 1 is provided with a plurality of dot structures 11), the light emitting efficiency of each embedment can be further increased by, for example, about 5% to 7%. However, the present disclosure is not limited thereto.

The backlight module described in the present disclosure can be combined with any display panel, so the electronic device disclosed in the present disclosure can be a display device. The display panel may be, for example, a flexible display panel, a touch display panel, a curved display panel or a tiled display panel, but the present disclosure is not limited thereto. The display device may be, for example, a display, a mobile phone, a notebook computer, a video camera, a camera, a music player, a mobile navigation device, a television, or any other electronic device that needs to display an image, but the present disclosure is not limited thereto.

The above specific embodiments should be construed as merely illustrative and not limiting in any way the remainder of the present disclosure.

Although the present disclosure has been explained in relation to its embodiment, it is to be understood that many other possible modifications and variations can be made without departing from the spirit and scope of the disclosure as hereinafter claimed.

1. An electronic device, comprising:
a backlight module, comprising:
a light guide plate;
a plurality of light sources disposed adjacent to a light incident side of the light guide plate and arranged along a first direction;
a first optical element disposed on the light guide plate and having a plurality of first prism structures,
wherein at least one of the plurality of first prism structures extends along the first direction, and the plurality of first prism structures face the light guide plate.

2. The electronic device of claim 1, wherein the backlight module further comprises a second optical element disposed on the first optical element and having a plurality of second prism structures, wherein at least one of the plurality of second prism structures extends along a second direction perpendicular to the first direction, and the plurality of second prism structure are away from the light guide plate.

3. The electronic device of claim 2, wherein the backlight module further comprises a third optical element disposed on the second optical element and having a plurality of third prism structures, wherein at least one of the plurality of third prism structures extends along the first direction, and the plurality of third prism structures are away from the light guide plate.

4. The electronic device of claim 3, wherein the backlight module further comprises a functional layer disposed on the third optical element, and the functional layer comprises a diffuser, an advanced polarization conversion film (APCF), a dual brightness enhancement film (DBEF) or a combination thereof.

5. The electronic device of claim 4, wherein the backlight module further comprises another functional layer disposed on the third optical element, and the functional layer comprises an advanced polarization conversion film (APCF), a dual brightness enhancement film (DBEF) or a combination thereof.

6. The electronic device of claim 5, wherein the functional layer is disposed between the another functional layer and the third optical element.

7. The electronic device of claim 3, wherein the third optical element comprises a base, and the plurality of third prism structures are disposed on the base, wherein a surface of the base away from the plurality of third prism structures has a haze greater than or equal to 15% and less than or equal to 45%.

8. The electronic device of claim 3, wherein the third optical element comprises a base with a multilayer structure, and the plurality of third prism structures are disposed on the multilayer structure, wherein the multilayer structure comprises a plurality of high refractive index films and a plurality of low refractive index films alternately disposed.

9. The electronic device of claim 2, wherein a refractive index of the second prism structure is greater than or equal to 1.62.

10. The electronic device of claim 9 wherein the refractive index of the second prism structure ranges from 1.62 to 1.7.

11. The electronic device of claim 1, wherein the light guide plate has a lower surface away from the first optical element, and a plurality of dot structures are disposed on the lower surface.

12. The electronic device of claim 1, wherein the light guide plate has a lower surface away from the first optical element, and the lower surface has a plurality of concave microstructures.

13. The electronic device of claim 12 wherein in a cross-sectional view, at least one of the plurality of the concave microstructure comprises a first side surface and a second side surface, an angle between the first side surface and an extension surface of the lower surface of the light guide plate is a first angle, an angle between the second side surface and the extension surface of the lower surface of the light guide plate is a second angle, and the first angle is different from the second angle.

14. The electronic device of claim 1, wherein a refractive index of the first optical element less than 1.62.

15. The electronic device of claim 1, wherein a refractive index of the first optical element is range from 1.45 to 1.61.

16. The electronic device of claim 3, wherein a refractive index of the third optical element less than 1.62.

17. The electronic device of claim 3, wherein a refractive index of the third optical element is range from 1.45 to 1.61.

18. The electronic device of claim 1, wherein at least one of the plurality of first prism structures has a first vertex angle ranging from 80° to 100°.

19. The electronic device of claim 1, wherein the backlight module further comprises a reflective element disposed under the light guide plate.

20. The electronic device of claim 1, wherein the first prism structures have strip shapes arranged along a second direction perpendicular to the first direction.
